(19) United States
(12) Patent Application Publication
(10) Pub. No.: US 2020/0324736 A1
(43) Pub. Date: Oct. 15, 2020

(54) A WINDSCREEN WIPER DEVICE OF THE FLAT BLADE TYPE

(71) Applicant: FEDERAL-MOGUL S.A., AUBANGE, (BE)

(72) Inventor: ELODIE STEINER, HERSERANGE (FR)

(21) Appl. No.: 16/305,571

(22) PCT Filed: Jun. 20, 2016
(86) PCT No.: PCT/EP2016/064212

§ 371 Date: Nov. 29, 2018

(51) Int. Cl. B60S 1/38

(52) U.S. Cl. CPC B60S 1/3808; B60S 2001/3836

(57) ABSTRACT

A windscreen wiper device of the flat blade type comprising an elastic, elongated carrier element, as well as an elongated wiper blade, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, wherein said wiper blade comprises an elongated upper holding part and an elongated lower wiping part of a flexible material, wherein said holding part holds said longitudinal strip, wherein said wiping part comprises a wiping lip, and wherein said holding part and said wiping part are interconnected by means of a tilting web, with the special feature that said wiper blade comprises noise dampening profiles forming stops for said wiping part at turning points of an oscillatory movement of said wiping part, wherein said noise dampening profiles are provided between said holding part and longitudinal sides of said wiping part facing towards said holding part, wherein said holding part comprises downwardly extending protrusions forming stops for said noise dampening profiles at said turning points of said oscillatory movement of said wiping part, and wherein said protrusions are located closer to a vertical median plane of said wiping part than stop locations for said wiping part on said noise dampening profiles.

### BACKGROUND

### 1. Technical Field

The present invention relates to a windscreen wiper device of the flat blade type comprising an elastic, elongated carrier element, as well as an elongated wiper blade, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, wherein the wiper blade comprises an elongated upper holding part and an elongated lower wiping part of a flexible material, wherein the holding part holds the longitudinal strip, wherein the wiping part comprises a wiping lip, and wherein the holding part and the wiping part are interconnected by means of a tilting web. Particularly, the oscillating arm can be pivotally connected to the connecting device with the interposition of a joint part. More in particular, the wiper blade comprises a spoiler at a side thereof facing away from the windscreen to be wiped, wherein the wiper blade and the spoiler are preferably made in one piece through extrusion, the longitudinal groove is preferably a central longitudinal groove accommodating the longitudinal strip, the longitudinal strip is also called a “flexor”, while the connecting device is also indicated as a “connector”. In the framework of the present invention the connector is preferably made in one piece, also called a “one piece connector”.

### 2. Related Art

Such a windscreen wiper device is generally known. The prior art windscreen wiper device is in particular designed as a “yokeless” wiper device or “flat blade”, wherein use is no longer made of several yokes pivotally connected to each other, but wherein the wiper blade is biased by the carrier element, as a result of which it exhibits a specific curvature. The holding part, the wiping part and the tilting web of the known windscreen wiper device are made in one piece.

A disadvantage of the known windscreen wiper device is the following. In practice the oscillating arm is connected to a mounting head fixed for rotation to a shaft driven by a small motor. In use, the shaft rotates alternately in a clockwise and in a counter-clockwise sense carrying the mounting head into rotation also, which in turn draws the oscillating arm into rotation and by means of the connecting device moves the wiper blade. The tilting web acts as an intermediate part subjected to a force in accordance with the wiping direction, the force acts solely on the tilting web, so that the wiping lip attached to the wiping part is guided in opposite direction to the wiping direction. Particularly, the tilting web is strip-shaped, whereas the wiping lip is triangular in shape. However, the oscillatory movement of the wiping lip along the windscreen to be wiped results in a significant reversal noise, particularly as a consequence of the wiping lip being tumbled over at each turning point of its oscillatory movement.

### SUMMARY

It is an object of the invention to improve the prior art, that is to provide a windscreen wiper device wherein the above disadvantage is obviated at minimum costs.

It is noted that the present invention is not restricted to windscreen wiper devices for cars, but that it also relates to windscreen wiper devices for rail coaches and all other (fast) vehicles.

In order to accomplish that objective, a windscreen wiper device of the kind referred to in the introduction according to the invention is characterized in that the wiper blade comprises noise dampening profiles forming stops for the wiping part at turning points of an oscillatory movement of the wiping part, wherein the noise dampening profiles are provided between the holding part and longitudinal sides of the wiping part facing towards the holding part, wherein the holding part comprises downwardly extending protrusions forming stops for the noise dampening profiles at the turning points of the oscillatory movement of the wiping part, and wherein the protrusions are located closer to a vertical median plane of the wiping part than stop locations for the wiping part on the noise dampening profiles, the vertical median plane of the wiping part is also a plane of symmetry of the wiping part, i.e. the wiping lip. In other words, the stop locations for the wiping part on the noise dampening profiles are beyond the protrusions, seen from the vertical median plane of the wiping part.

The present invention is particularly based on the awareness that the reversal noise resulting from the oscillatory movement of the wiping part or wiping lip along the windscreen to be wiped, particularly as a consequence of the wiping part being tumbled over at each turning point of its oscillatory movement, can be considerably reduced by exerting an increasing pressure onto the wiping part by the noise dampening profiles on each side of the tilting web. Firstly, when the wiping lip engages one of the noise dampening profiles on one side of the tilting web, the wiping lip would encounter a counter force due to the resiliency of this noise dampening profile. Secondly, when the wiping lip forces the noise dampening profile to further bend laterally outwardly until the latter engages one of the downwardly extending protrusions on the side of the tilting web, the wiping lip would encounter an increased counter force due to the rigidity of this downwardly extending protrusion. Thirdly, when a free end or extremity of the noise dampening profile is further deformed by the wiping lip, the wiping lip would encounter a maximum counter force due to the resiliency of this free end extremity. Experiments have shown that the noise caused by the wiping lip being swung over at each turning point of its oscillatory movement, is thus minimalized.

The use of the downwardly extending protrusions of the holding part has the additional advantage that their location, i.e., their distance to the medial vertical plane of the wiping part, can easily adjusted in a manufacturing die in the event that a smaller or larger wiping part is used.

It is noted that the present invention is not restricted to the use of only one longitudinal strip forming the elastic carrier element that is particularly located in a central longitudinal groove of the wiper blade. Instead, the carrier element may also comprise two longitudinal strips, wherein the strips are disposed in opposite longitudinal grooves of the wiper blade, the groove(s) may be closed at one outer end.

Further, it is noted that in the invention use is made of a mounting head fixed for rotation to a shaft, wherein the shaft is rotatable alternately in a clockwise and in a counter-clockwise sense carrying the mounting head into rotation. Thus, in turn the mounting head draws the connecting device into rotation and thereby moves the wiper blade. In the alternative, the mounting head is fixed for translation to a carriage, wherein the carriage can be translated alternately in a one linear direction and in another counter linear direction carrying the mounting head into translation. The present invention can therefore be used for circular or linear movement of the mounting head.

In one preferred embodiment of a windscreen wiper device in accordance with the invention the protrusions are located at a distance from the vertical median plane of the wiping part chosen in the range of 1 mm and 2.5 mm. Preferably, the stop locations for the wiping part on the noise dampening profiles are located at a distance from the vertical median plane of the wiping part chosen in the range of 1, 2 mm and 3 mm.

In another preferred embodiment of a windscreen wiper device according to the invention the protrusions extend downwardly from flat longitudinal sides of the holding part facing towards the wiping part.

In another preferred embodiment of a windscreen wiper device in accordance with the invention the holding part, the wiping part, the noise dampening profiles and the protrusions are made in one piece of material. Particularly, the wiper blade is made in one piece of elastomer material, that is that the holding part, the wiping part, the noise dampening strips and the protrusions (the tilting web inclusive) are integral.

In another preferred embodiment of a windscreen wiper device according to the invention the noise dampening profiles are formed by strips arranged at an acute angle to the holding part. Preferably, the protrusions are in the shape of a V.

The invention also relates to a wiper blade as defined by a windscreen wiper device in accordance with the invention preferably made by extrusion or injection molding.

### THE DRAWINGS

The invention will now be explained in more detail with reference to figures illustrated in a drawing, wherein;

FIG. 1 is a perspective, schematic view of a preferred embodiment of a windscreen wiper device according to the invention; and

FIGS. 2 through 7 are cross-sectional views of the windscreen wiper device of FIG. 1 and show in successive steps how an increased pressure is exerted on a wiping part thereof in accordance with the invention.

### DETAILED DESCRIPTION

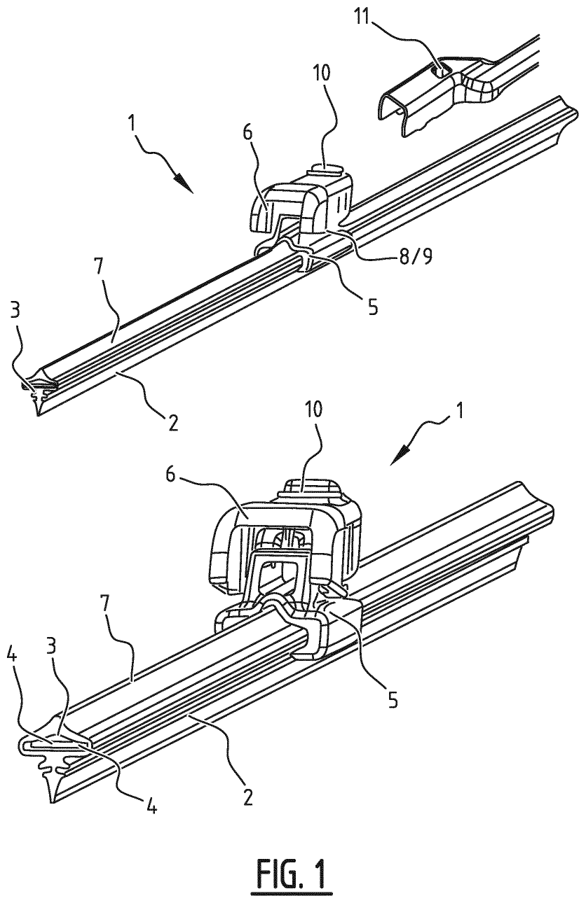

FIG. 1 shows a preferred variant of a windscreen wiper device 1 according to the invention, the windscreen wiper device 1 is built up of an elastomeric wiper blade 2 comprising a central longitudinal groove 3, wherein a longitudinal strip 4 made of spring band steel is fitted in the longitudinal groove 3, the strip 4 forms a flexible carrier element for the rubber wiper blade 2, as it were, which is thus biased in a curved position (the curvature in operative position being that of a windscreen to be wiped). The windscreen wiper device 1 is furthermore built up of a connecting device 5 of metal or plastic for connecting an oscillating wiper arm thereto, with the interposition of a joint part 6. The oscillating wiper arm is pivotally connected to the connecting device 5 about a pivot axis near one end. The preferred embodiment of FIG. 1 according to the invention comprises a spoiler or “air deflector” 7 which is made in one piece with the rubber wiper blade 2 and which extends along the entire length thereof. No end caps are used, but free ends of the wiper blade 2 are cut at an oblique angle. In the alternative end caps may be used.

Although not shown in FIG. 1, but fully understood by a skilled person, the oscillating arm is connected to a mounting head fixed for rotation to a shaft driven by a small motor. In use, the shaft rotates alternately in a clockwise and in a counter-clockwise sense carrying the mounting head into rotation also, which in turn draws the oscillating arm into rotation and by means of the connecting device 5 moves the wiper blade 2.

The joint part 6 is detachably connected to the connecting device 5 by engaging protrusions 8 of the connecting device 5, at the location of the pivot axis, in co-axial recesses 9 provided in the joint part 6. As will be clear, the protrusions 8 extend outwards on either side of the connecting device 5. The joint part 6 comprises a resilient tongue 10 extending outwardly, while the oscillating arm has a U-shaped cross-section at the location of its connection to the joint part 6, so that the tongue 10 engages in an identically shaped hole 11 provided in a base of the U-shaped cross-section. The connecting device 5 with the wiper blade 2 is mounted onto the oscillating arm as follows. The joint part 6 being already clipped onto the connecting device 5 is pivoted relative to the connecting device 5, so that the joint part 6 can be easily slided on a free end of the oscillating arm. During this sliding movement the resilient tongue 10 is initially pushed in against a spring force and then allowed to spring back into the hole 11 in the oscillating arm, thus snapping, that is clipping the resilient tongue 10 into the hole 11 of the oscillating arm. This is a so-called bayonet-connection. The oscillating arm together with the joint part 6 may then be pivoted back in a position parallel to the wiper blade 2 in order to be ready for use. By subsequently pushing in again the resilient tongue 10 against the spring three (as if it were a push button), the connecting device 5 and the joint part 6 together with the wiper blade 2 may be released from the oscillating arm. Dismounting the connecting device 5 with the wiper blade 2 from the oscillating arm is thus realized by sliding the connecting device 5 and the joint part 6 together with the wiper blade 2 in a direction away from the oscillating arm.

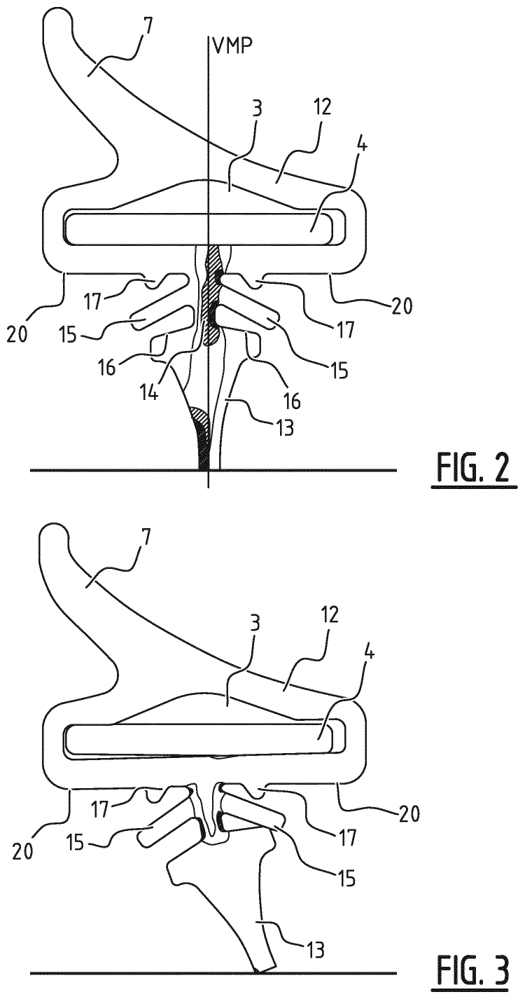

With reference to FIGS. 2 through 7 the wiper blade 2 comprises an elongated upper holding part 12 and an elongated lower wiping part of 13, the holding part 12 holds the longitudinal strip 4, whereas the wiping part 13 comprises a wiping lip with a triangular cross-section, the holding part 12 and the wiping part 13 are interconnected by means of a tilting web 14 and are in one piece of material, the wiper blade 2 comprises noise dampening profiles formed by two strips 15 arranged at an acute angle to the holding part 12. As shown, the strips 15 are provided between the holding part 12 and holding-part-side longitudinal sides or edges 16 of the wiping part 13.

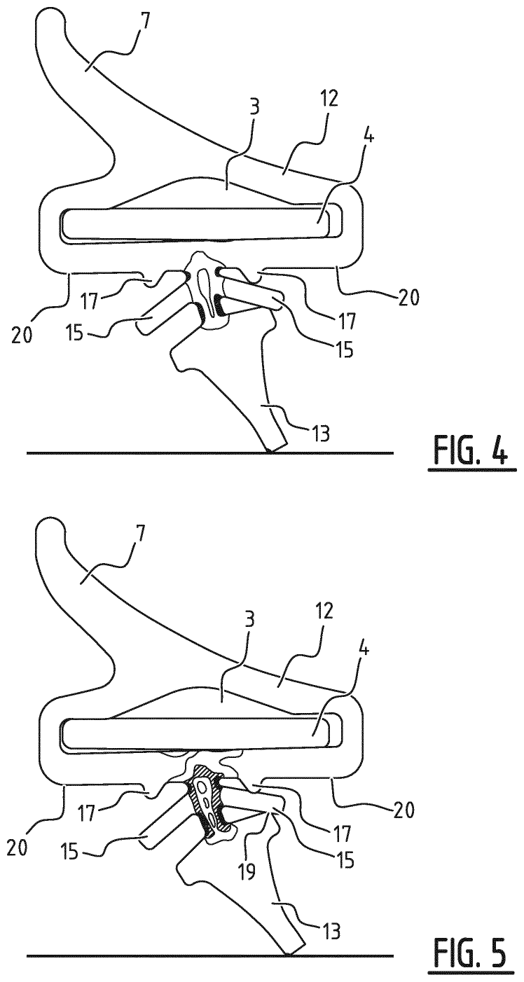

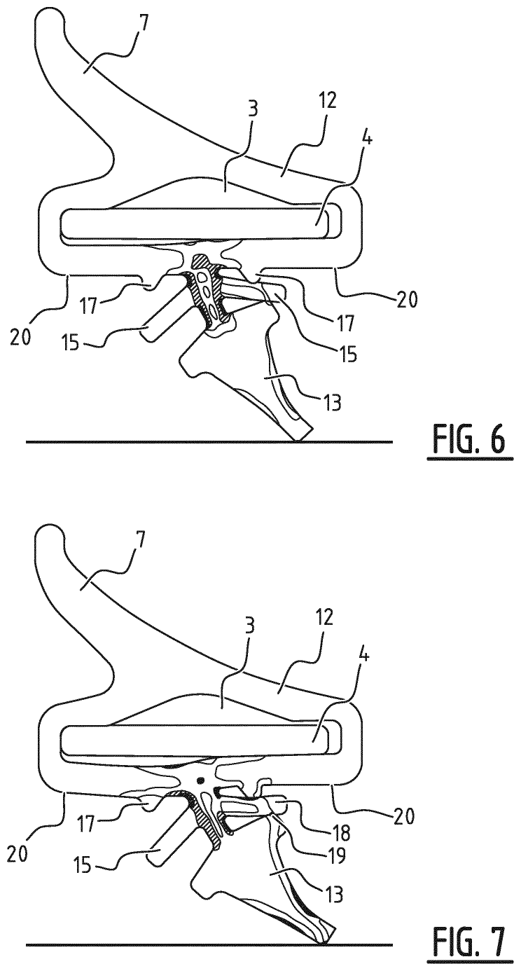

In FIG. 2 the wiping part 13 is shown in its central or middle position during its oscillatory movement, while in FIGS. 3 through 6 the wiping part 13 is moved to its turning point of its oscillatory movement. In FIG. 7 the wiping part 13 is at its tumble or turning point of oscillatory movement. As shown in FIGS. 2 through 7 the strips 15 form stops for shoulders of the wiping part 13 towards and at its turning point of its oscillatory movement. When the wiping part 13 engages one of the strips 15 on one side of the tilting web 14, the wiping part 13 encounters a counter force due to the resiliency of this strip 15 (FIG. 3). This counter force is increased when this strip 15 is forced by the wiping part 13 to further bend laterally outwardly (FIG. 4). The wiping part 13 encounters an even higher counter force when the strip 15 is forced to further bend laterally outwardly in order to engage a downwardly extending protrusions 17 on the side of the tilting web 14 due to the rigidity of this downwardly extending protrusion 17 (FIGS. 5 and 6). In FIG. 7 is shown that a free end or extremity 18 of the strip 15 is further deformed by the wiping part 13, so that the wiping part 13 encounters a maximum counter force due to the resiliency of this free end/extremity 18. This made possible because the protrusions 17 are located closer to a vertical median plane VMP of the wiping part 13 than stop locations 19 for the wiping part 13 on the strips 15. As depicted, the protrusions 17 extend downwardly from flat longitudinal sides or edges 20 of the holding part 12 facing towards the wiping part 13.

The holding part 12, the wiping part 13, the noise dampening strips 15 and the protrusions 17 are made in one piece of material.

The present invention is not restricted to the embodiment shown, but also extends to other preferred variants falling within the scope of the appended claims,

1. A windscreen wiper device of the flat blade type comprising an elastic, elongated carrier element, as well as an elongated wiper blade, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, wherein said wiper blade comprises an elongated upper holding part and an elongated lower wiping part of a flexible material, wherein said holding part holds said longitudinal strip, wherein said wiping part comprises a wiping lip, and wherein said holding part and said wiping part are interconnected by a tilting web, wherein said wiper blade comprises noise dampening profiles forming stops for said wiping part at turning points of an oscillatory movement of said wiping part, wherein said noise dampening profiles are provided between said holding part and longitudinal sides of said wiping part facing towards said holding part, wherein said holding part comprises downwardly extending protrusions forming stops for said noise dampening profiles at said turning points of said oscillatory movement of said wiping part, and wherein said protrusions are located closer to a vertical median plane of said wiping part than stop locations for said wiping part on said noise dampening profiles.

2. A windscreen wiper device according to claim 1, wherein said protrusions are located at a distance from said vertical median plane of said wiping part in the range of 1 mm and 2.5 mm.

3. A windscreen wiper device according to claim 1, wherein said stop locations for said wiping part said noise dampening profiles are located at a distance from said vertical median plane of said wiping part in the range of 1, 2 mm and 3 mm.

4. A windscreen wiper device according to claim 1, wherein said protrusions extend downwardly from flat longitudinal sides of said holding part facing towards said wiping part.

5. A windscreen wiper device according to claim 1, wherein said holding part, said wiping part, said noise dampening profiles and said protrusions are made in one piece of material.

6. A windscreen wiper device according to claim 1, wherein said noise dampening profiles are formed by strips arranged at an acute angle to said holding part.

7. A windscreen wiper device according to claim 1, wherein said protrusions are in the shape of a V.

8. A wiper blade which can be placed in abutment with a windscreen to be wiped, which wiper blade includes at least one longitudinal groove, in which groove a longitudinal strip is disposed wherein said wiper blade comprises an elongated upper holding part and an elongated lower wiping part of a flexible material, wherein said holding part holds said longitudinal strip, wherein said wiping part comprises a wiping lip, and wherein said holding part and said wiping part are interconnected by a tilting web, wherein said wiper blade comprises noise dampening profiles forming stops for said wiper part at turning points of an oscillatory movement of said wiping part, wherein said noise dampening profiles are provided between said holding part and longitudinal sides of aid wiping part facing towards said holding part, wherein said holding part comprises downwardly extending protrusions forming stops for said noise dampening profiles at said turning point of said oscillatory movement of said wiping part, and wherein said protrusions are located closer to a vertical median plain (VMP) of said wiping part than stop locations for said wiping part on said noise dampening profiles as defined by a windscreen wiper device according to claim 1.
